(19) United States
(12) Patent Application Publication
(10) Pub. No.: US 2005/0260014 A1
(43) Pub. Date: Nov. 24, 2005

(54) Developer level control blade, process for its manufacture, and developing assembly

(75) Inventors: Naohiko Nakano, Tsukuba-shi (JP); Toru Ishigaki, Matsudo-shi (JP); Kazuaki Iwata, Toride-shi (JP); Keiko Taga, Ushiku-shi (JP)

Correspondence Address: FITZPATRICK CELLA HARPER & SCINTO, 30 ROCKEFELLER PLAZA, NEW YORK, NY, 10112, US

(73) Assignee: Canon Kasei Kabushiki Kaisha, Tsukuba-shi (JP)

(21) Appl. No.: 11/132,259

(22) Filed: May 19, 2005

(30) Foreign Application Priority Data
May 20, 2004 (JP) 2004-150694 (PAT.
May 20, 2004 (JP) 2004-150695 (PAT.
May 17, 2005 (JP) 2005-144037 (PAT.

(51) Int. Cl. G03G 15/08

(52) U.S. Cl. 399/284

(57) ABSTRACT

To provide a developer level control blade which ensures uniform wear of its blade member, enables well precise control of the touch pressure against the developer carrying member to achieve a proper pressure against the developer, and can keep the toner melt adhesion from occurring even in long-term service, a developer level control blade is used which has a stated peripheral shape, is to be disposed in touch with a developer carrying member for transporting a developer, holding the developer on its surface, and is used to control the level of the developer to be held on the surface of the developer carrying member. The control blade has a laminated structure in which a support member and a blade member are bonded, and the blade member has a stated surface free energy.

### BACKGROUND OF THE INVENTION

1. Field of the Invention

This invention relates to a developer level control blade used to control the level (extent of quantity) of a developer held on the surface of a developer carrying member through means of which the developer is fed to electrostatic latent images formed on an image bearing member, to render the latent images visible. It also relates to a process for its manufacture, and a developing assembly having this developer level control blade.

2. Related Background Art

In electrophotographic apparatus, which utilize electrophotographic systems to form images, such as copying machines, facsimile machines and printers, developers such as toners are used to develop (render visible) the electrostatic latent images formed on an image bearing member such as a photosensitive member. To feed the developer to the surface of the image bearing member, a system is usually used in which a developer kept held in a developer container is made held on the surface of a developer carrying member and the developer held on the surface of the developer carrying member is fed to an electrostatic latent image forming zone of the image bearing member to make the former adhere to the latter. The level of the developer on the surface of the developer carrying member is controlled by a blade brought into touch with it at that zone.

FIG. 4 shows an example of a developing assembly making use of such a system. In the developing assembly shown in FIG. 4, a one-component developer (also called a toner) 46 for example, held in a developer container 42, is pressed against, and made to stick to, a developer carrying member (also called a developing sleeve or developing roller) 43 by means of an elastic roller 45 which rotates in the direction of an arrow c. Thereafter, as the developer carrying member 43 is rotated in the direction of an arrow b, the developer is carried out of the developer container to an electrophotographic photosensitive member 41 which rotates in the direction of an arrow a. In such a mechanism, a blade member 47 of a developer level control blade 44 is kept in touch with the developer carrying member 43, and the level of the developer carried out of the container is controlled (regulated), where a thin layer of the developer is formed and at the same time the developer is provided with stated triboelectric charges (also called triboelectricity) at the touching zone.

The developer level control blade is commonly formed of a rubber plate, a metallic sheet, a resin plate or a laminate of members selected from these. As an example, it may include a developer level control blade constituted of a blade member to be kept in pressure touch with the developer carrying member and a support member which supports this blade member at a preset position. The face of the blade member that is kept in pressure touch with the developer carrying member has the function to control the triboelectric charges of the developer. Accordingly, this face is also called a charge control face. The surface layer of this charge control face is also called a charge control layer in some cases.

As developer level control blades used for positive-type toners, those obtained by laminating a charge-providing layer of charge-controlled silicone rubber or the like to a metallic sheet are used. As developer level control blades used for negative-type toners, plate members made of urethane rubbers, urethane resins, polyester elastomers or polyamide elastomers are used, for example. As a manufacturing method, a method making use of a mold having a mirror face is disclosed. Also, as to the blade members made of urethane rubbers, too, an example is reported in which the charge control face is similarly formed by mold face transfer (Japanese Patent Application Laid-open No. H09-050185).

However, where the method disclosed in this publication is employed, the surface properties of the charge control face are influenced by how the mold mirror face is maintained and controlled, and there is a possibility of resulting in non-uniform product quality depending on how it has been controlled.

As a developer control method in which the blade member may uniformly wear and can control touch pressure in a good precision to achieve a pressure that is proper to toner particles, an example is also reported in which a control blade having a structure as a laminate formed by laminating the blade member and the metallic sheet as a support member layer to have both the same peripheral (contour) shapes, i.e., a laminate whose peripheral edge face embraces both the edge face of the blade member and the edge face of the support member is used so that faulty images such as lines and non-uniform images can be kept from being caused by the developer (Japanese Patent Applications Laid-open No. 2002-372858 and No. 2002-372859). However, where the developer level control blade disclosed in this publication is employed, there is concern about the toner melt adhesion that may be caused during long-term service, and further measures are required to be taken.

Meanwhile, an example is also reported in which a high-rigidity resin is used in the support member of the blade member and a thermoplastic elastomer such as polyurethane or polyester is employed in the blade member (Japanese Patent Applications Laid-open No. 2001-255738 and No. 2001-356595). However, where such a high-rigidity resin is used while image processing is being made more high-speed and highly durable, it is expected that compression set may come about to make it difficult to make proper control of developer level over a long period of time. In addition, no effect is seen about the toner melt adhesion to be kept from occurring.

As to the effect of keeping the toner melt adhesion from occurring in making the image processing highly durable, an example is reported in which the surface energy of the blade member is controlled to make the blade member readily abradable so that the toner melt adhesion can be kept from occurring over a long period of time (Japanese Patent Application Laid-open No. H11-223988). However, at present where the image processing is being made further high-speed, such a blade member is expected to be abraded at a large level, and there is a possibility that any uniform coat layer of the developer can not be achieved because of abrasion, depending on the surface state of the developer carrying member.

Thus, as the electrophotographic process is made high-speed and highly durable, the developer level control blade is more required to satisfy the controlling of the level of toners having been made fine-particle and the face precision and uniform pressure touch of the charge control face, and at the same time to keep the toner melt adhesion from occurring

Moreover, with regard to non-magnetic toners used in the formation of color images, its thin layer must be formed on a developing sleeve or a developing roller, providing the toner with high triboelectric charges, because the toner itself does not have any magnetic properties. In this case, as materials used in the charge control layer, they may include urethane rubbers, polyamide resins, polyester elastomers, polyamide elastomers, silicone rubbers and silicone resins. The use of these materials enables the charge control face to be finished in a good precision.

In recent years, fine-particle toners are used in developing assemblies having been made high-quality and full-color in which an electrophotographic process is applied, and hence the toners are required to be more uniformly pressed against, and made stick to, the developing sleeve (developing roller as the developer carrying member). Especially where the charge control face has no suitable surface roughness, faulty images such as non-uniform images and lines may occur because of its influence.

In addition, as the printing is being made more high-speed and highly durable on account of the needs in the market, cases have come about in which faulty images such as lines and non-uniform images due to developers acting on the charge control face and vertical lines due to toner melt adhesion occur because of long-term service.

Now, in making image quality higher and making images full-color in the image formation in which an electrophotographic process is applied, the toner layer on the developing sleeve (developing roller) has become required to be made more thin-layer because toners have been made very small in particle diameter. Further, in addition to such image quality made higher and full-color image formation, it has become essential for the image processing to be made high-speed and for the apparatus to be made highly durable. Under such circumstances, the desired triboelectric charge quantity is achieved by making charge control at a relatively high pressure when a developer level control blade available in the existing condition is used. However, such a strong charge control pressure may cause early deterioration of toners and may cause contamination of the charge control face of the blade member because of its long-term service. These may more early occur in the case of one-component developers than in the case of two-component developers making use of magnetic toners. As the result, toner sticking matter may come deposited on the charge control face kept in touch with the developer carrying member during long-term service, and the toner can not properly be charged to cause fog or enable no incorporation of the toner in a uniform and proper level, and cause faulty images such as development lines, a phenomenon in which white lines appear in image areas.

Where on the other hand charges are controlled at a relatively low pressure, the toner may slip through in a quantity larger than the desired one, or toner particles having large particle diameter may gather at charge control portions, so that faulty images such as non-uniform images and lines may occur.

In order to prevent the toner from thus sticking and keep fog and development lines from occurring, a developer level control blade member is presented which is provided with at least two resin layers consisting of an uppermost layer formed of a resin, having a surface free energy of 30 dyn/cm or less as a developer level control blade, and a resin coat layer having a hardness higher than the hardness of the uppermost layer (Japanese Patent Application Laid-open No. H11-223988). Where, however, the blade has a too small surface free energy, there is a possibility that the quality of the developer carrying member is more greatly influenced as the developing process becomes more high-speed and highly durable; the developer carrying member being roughened to have the desired surface shape in order to transport the toner.

A developer level control blade is also presented in which a low-molecular weight substance and so forth contained in the blade member are extracted so that their exudation can be controlled to make the toner adhere onto the charge control face with delay (Japanese Patent Applications Laid-open No. H11-242386 and No. H11-282252). However, even if such a substance and so forth are extracted to make any bleeded matter less form, there is a possibility that the toner melt adhesion occurs as long as the blade member has originlly a poor adhesion.

Thus, in the developer level control blade, as the image processing is being made more high-speed and the appratus are being made more highly durable, it is more required to keep the toner from sticking or melt-adhering to the charge control face of the blade member kept in touch with the developer carrying member, and to control the developer level at a low stress to toner particles.

### SUMMARY OF THE INVENTION

In view of the circumstances as stated above, an object of the present invention is to provide a developer level control blade which ensures uniform wear of its blade member, enables well precise control of the touch pressure against the developer carrying member to achieve a proper pressure against the developer, and besides can keep the toner melt adhesion from occurring even in long-term service; and to provide a process for its manufacture.

Another object of the present invention is to provide a developing assembly which makes use of this developer level control blade to keep lines in images and non-uniform images from occurring because of faulty control for the developer, and faulty images such as vertical lines in images from occurring because of the toner melt adhesion.

Still another object of the present invention is to provide a developer level control blade which, during long-term service (especially under high-speed conditions of image processing), can make stable the charge-providing performance to toner, can keep development lines from occurring because of the sticking or melt-adhering of toner to the charge control face of the blade member kept in touch with the developer carrying member, and can control the developer level at a low stress to toner particles; and to provide a developing assembly making use of the same.

The developer level control blade according to the present invention is a developer level control blade which has a stated peripheral shape, is to be disposed in touch with a developer carrying member for transporting a developer, holding the developer on its surface, and is used to control the level of the developer to be held on the surface of the developer carrying member; the control blade having a laminated structure in which a support member and a blade member are bonded; wherein; said blade member is formed of an elastic material containing at least a resin having a polar group, where the surface free energy γs of the surface that is to come into touch with the developer carrying member, of said blade member is represented by the sum total of a dispersion component γsd, a bipolar component γsp and a hydrogen bond component γsh, the surface free energy γs is 65 mN/m or less, the bipolar component γsp is 35 mN/m or less and the hydrogen bond component γsh is 5 mN/m or less.

The blade member has preferably a Shore D hardness of from 25 degrees to 78 degrees, and is preferably formed of a polyester elastomer.

The developing assembly according to the present invention is a developing assembly which comprises a developer carrying member for holding a developer on its surface to carry the developer out of a developer container, and a developer level control blade kept in touch with the developer carrying member, for controlling the level of the developer held on the surface of the developer carrying member, wherein;
the developer level control blade is the developer level control blade constituted as described above.

In a first embodiment of the process for manufacturing the developer level control blade according to the present invention is a process for manufacturing a developer level control blade which has a stated peripheral shape, is to be disposed in touch with a developer carrying member for transporting a developer, holding the developer on its surface, and is used to control the level of the developer to be held on the surface of the developer carrying member; the process comprising the steps of:
extruding a elastic raw material containing a resin having a polar group, onto a charge control face face-transferring sheet, followed by solidification to prepare on a charge control face face-transferring sheet a blade member layer in which, where the surface free energy γs of the surface that is to come into touch with the developer carrying member is represented by the sum total of a dispersion component γsd, a bipolar component γsp and a hydrogen bond component γsh, the surface free energy γs is 65 mN/m or less, the bipolar component γsp is 35 mN/m or less and the hydrogen bond component γsh is 5 mN/m or less;
laminating and bonding a support member layer to the top surface of the blade member layer to obtain a laminate; and
cutting the laminate in a stated peripheral shape to obtain a developer level control blade having a laminated structure in which a blade member and a support member are bonded.

The blade member is preferably formed of a polyester elastomer having a Shore D hardness of from 25 degrees to 78 degrees.

In a second embodiment of the process for manufacturing the developer level control blade according to the present invention is a process for manufacturing a developer level control blade which has a stated peripheral shape, is to be disposed in touch with a developer carrying member for transporting a developer, holding the developer on its surface, and is used to control the level of the developer to be held on the surface of the developer carrying member; the process comprising the steps of:
co-extruding i) a face transferring sheet forming molten resin material which is to form a charge control face face-transferring sheet and ii) a molten resin material for forming a blade member comprising an elastomer containing a resin having a polar group, followed by shaping into a cylindrical form by multi-layer blown-film extrusion to obtain a cylindrical product in which a face transferring sheet and a blade member layer are laminated in which, where the surface free energy γs of the surface that is to come into touch with the developer carrying member is represented by the sum total of a dispersion component γsd, a bipolar component γsp and a hydrogen bond component γsh, the surface free energy γs is 65 mN/m or less, the bipolar component γsp is 35 mN/m or less and the hydrogen bond component γsh is 5 mN/m or less;
cutting the cylindrical product in parallel to the direction of extrusion to form at least one raw-material sheet;
laminating a support member layer to the raw-material sheet on its blade member layer to obtain a laminate; and
cutting the laminate in a stated peripheral shape to obtain a developer level control blade having a laminated structure in which a blade member and a support member are bonded.

The blade member is preferably formed of a polyester elastomer having a Shore D hardness of from 25 degrees to 78 degrees.

### BRIEF DESCRIPTION OF THE DRAWINGS

FIG. 1 is a diagrammatic sectional view to illustrate the developer level control blade of the present invention.

FIGS. 2A and 2B are diagrammatic sectional views to illustrate a conventional developer level control blade.

FIGS. 3A, 3B and 3C are diagrammatic views to illustrate the developer level control blade of the present invention; FIGS. 2A and 2C, top plan views, and FIG. 2B, a sectional view.

FIG. 4 is a diagrammatic sectional view to illustrate a developing assembly.

FIG. 5 is a diagrammatic sectional view to illustrate an electrophotographic apparatus.

FIGS. 6A and 6B are diagrammatic sectional views to illustrate a developer level control blade manufacturing process of the present invention.

FIG. 7 is a diagrammatic sectional view to illustrate the structure of a circular die.

FIGS. 8A and 8B are diagrammatic sectional views to illustrate another developer level control blade manufacturing process of the present invention.

FIG. 9 is a diagrammatic sectional view to illustrate an instrument for evaluating the properties of the developer level control blade.

FIG. 10 is a diagrammatic sectional view to illustrate the developer level control blade of the present invention.

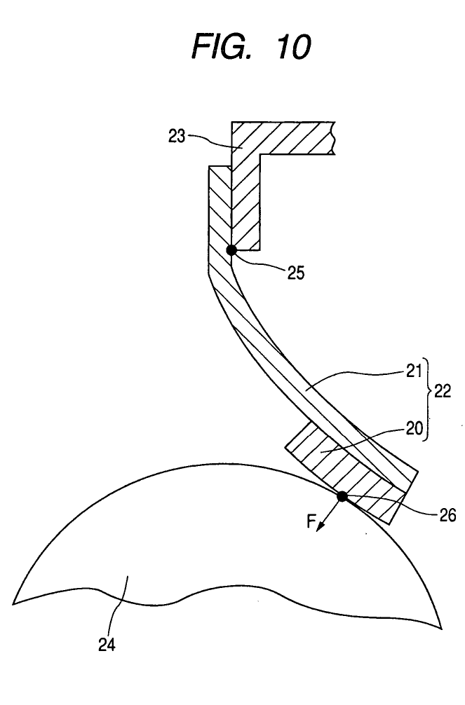

### DESCRIPTION OF THE PREFERRED EMBODIMENTS

The present inventors have made studies in the following way, on the mechanism by which the faulty images such as lines and non-uniform images as stated above occur when conventional developer level control blades are used.

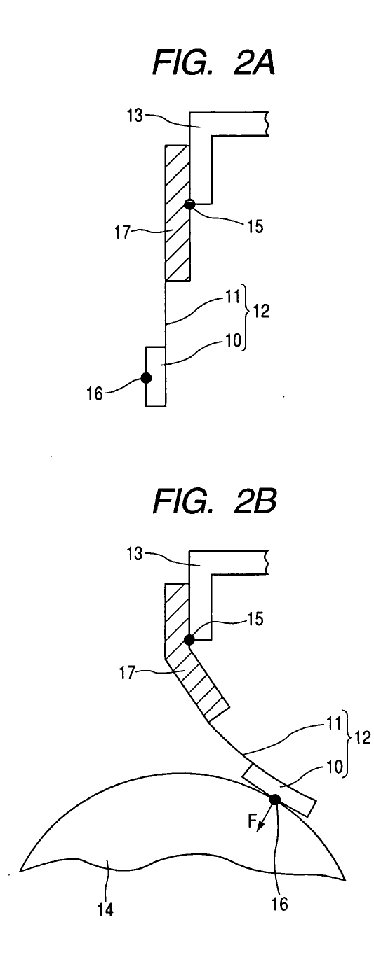

FIGS. 2A and 2B diagrammatically illustrate a conventional developer level control blade 12. FIG. 2A shows a state in which the developer level control blade 12 is not kept in pressure touch with a developer carrying member, and FIG. 2B shows a state in which the developer level control blade 12 is kept in pressure touch with a developer carrying member 14.

As shown in FIG. 2A, the developer level control blade 12 consists basically of a blade member 10 and a support member 11, and is fastened to a developer container 13 via a fitting member 17 at a fastening point 15 as an axis. When such a developer level control blade 12 is brought into pressure touch with the developer carrying member 14, as shown in FIG. 2B, the developer level control blade 12 comes bent, so that a pressure touching force F is applied to a developer (not shown) on the developer carrying member 14 at a pressure touch point 16.

Here, the present inventors have observed in detail the shape of the developer level control blade 12 at the time the conventional developer level control blade 12 is kept in pressure touch with the developer carrying member 14. As the result, they have found that the developer level control blade 12 does not stand bent uniformly as a whole, but the developer level control blade 12 may stand bent, e.g., at the part of the support member 11 to which the blade member 10 is not bonded, and in the vicinity of an end of the blade member 10 in the support member 11. This is considered due to the following: As shown in FIG. 2A, in the conventional developer level control blade 12, the blade member 10 is provided only at the pressure touch point 16 and in the vicinity thereof, at an end of the support member 11. Hence, the support member 11 has the part to which the blade member 10 is laminated and the part to which the blade member 10 is not laminated. Thus, the developer level control blade 12 comes bent without being uniformly curved.

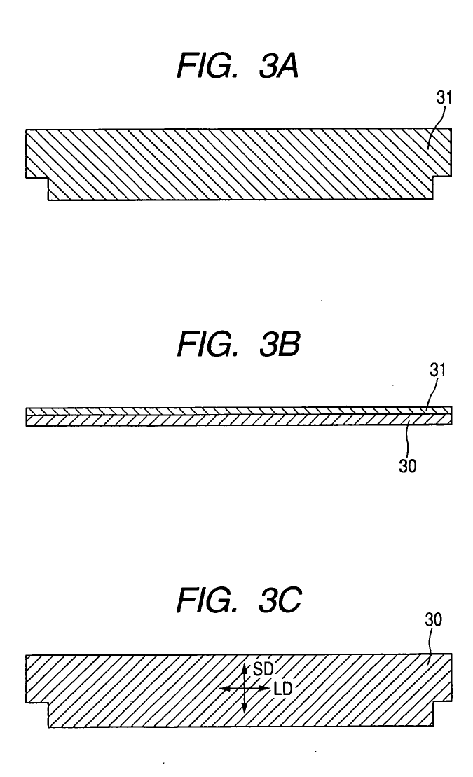

On the other hand, in the developer level control blade of the present invention, at least the blade member and the support member are laminated to each other in the same peripheral shape as the developer level control blade. FIGS. 3A and 3B show an example of such a developer level control blade, as a top plan view in FIG. 3A and a cross-sectional view at the middle in the lengthwise direction in FIG. 3B.

A blade member 30 and a support member 31 are laminated and bonded together over the whole area of the developer level control blade. Thus, the blade member 30 and the support member 31 each have the same planar shape as the planar shape of the developer level control blade. In other words, both the peripheral shape of the support member and that of the blade member form the peripheral shape of the blade. That is, these peripheral shapes are identical with the peripheral shape of the blade, where the peripheral edge (side) of the support member and the peripheral edge (side) of the blade member are positionally in agreement, and the peripheral edge face of the whole blade is formed by both edge faces of these. Incidentally, as long as the intended effect of the present invention can be achieved, the sides of the support member and blade member need not constitute the side of the blade in an exact agreement, and the support member may at least be bonded to the whole back surface of the blade member in the state the support member is made integral in substantially uniform thickness to its fitting portion at a fastening point.

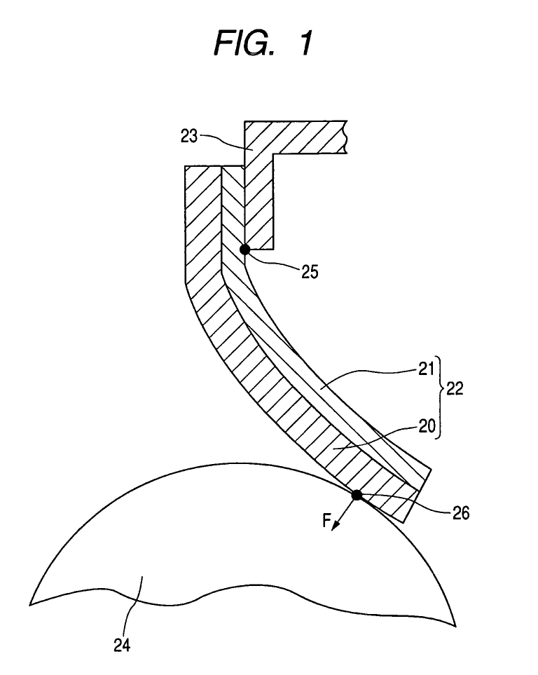

FIG. 1 shows as an example how a blade having the above constitution is used in the developing assembly. In the developing assembly shown in FIG. 1, a developer level control blade 22 produced by laminating a blade member 20 to a support member 21 is fastened to a developer container 23 at a fastening point 25 and is kept in pressure touch with a developer carrying member 24 at a pressure touch point 26 to exert pressure touching force F. Here, a laminated structure consisting of the support member and the blade member is continuously formed from an end at which the blade is fastened at the fastening point 25 up to both end portions at the position extending toward the other free end through the part coming into touch with the developer carrying member 24. Hence, the fulcrum (supporting point) of the moment in respect to the force necessary for the action of rubbing friction of the developer level control blade with the developer carrying member does not come in the middle of the developer level control blade. For this reason, the force that may otherwise make the developer level control blade bend in the middle thereof because of a difference in materials between the blade member and its support member can be kept from concentrating, so that the developer level control blade bends substantially uniformly over the whole. As the result, the blade member can be kept from wearing non-uniformly, as so considered.

The blade member is also laminated to the support member over its whole area, and hence the developer level control blade 22 bends gently as a whole. In other words, the blade member 20 is present up to the end portion (the fastening point 25 side) opposite to the rubbing-friction end portion, and hence it follows that the moment produced correspondingly to the pressure touching force acts on the part of rubbing friction through a long arm, so that the pressure touching force acts gently and well efficiently on developer particles, as so considered.

Thus, the uniform wear of the blade member can be achieved. Also, the pressure touching force against the developer carrying member can be controlled in a good precision to achieve a proper pressure against the developer such as toner particles. Then, the developer level control blade of the present invention may be disposed in the the developing assembly, and this enables the faulty images such as lines and non-uniform images due to any faulty control of the developer level on the developer carrying member to be kept from occurring even in the case when, e.g., the one-component developer is used.

An embodiment of the developer level control blade of the present invention is described below in detail.

The present inventors have made studies on the mechanism by which the toner melt adhesion occurs during long-term service, which have been made in the following way.

The developer is usually constituted of toner base particles and organic or inorganic fine particles called an external additive, which assists the former's triboelectric charging. The developer is triboelectrically charged when it passes a touching zone between the developer carrying member and the developer level control blade, where, at the same time, the external additive adheres to the surface of the blade member. It has been found that, where such an external additive continues to adhere thereto, the function of charge-providing performance that is inherent in the blade member may lower, so that toner particles having not acquired any sufficient charges may stagnate at the touching zone to cause melt adhesion of toner to the blade and so forth because of the heat generated by friction. As the result, it has come to light that, even in blade members having similar charge-providing performance to toner, how the external additive adheres to the blade member differs depending on materials for blade members, and it has been found that this is influenced by, in particular, the surface free energy of the charge control face and that materials having lower values in this surface free energy are more suitable to keep the toner melt adhesion from occurring. From these findings, they have reached the conclusion that a blade member capable of keeping the external additive from adhering or, even when the external additive has adhered to the charge control face, capable of readily coming off is a blade member which is formed of a polyester elastomer and in which, where its surface free energy (γs) is represented by the sum total of a dispersion component (γsd), a bipolar component (γsp) and a hydrogen bond component (γsh), the surface free energy (γs) is 65 mN/m or less, and preferably 61 mN/m or less, the bipolar component (γsp) is 35 mN/m or less, and preferably 26 mN/m or less, and the hydrogen bond component (γsh) is 5 mN/m or less, and preferably 4 mN/m or less; in particular, one having a structure which has an aromatic group adjoining to the ester linkage.

As the material for forming the blade member, it may include polyester resins, polyester type elastomers, polyurethane resins, polyurethane elastomers, polyamide resins and polyester elastomers, all having chargeability reverse to that of the toner. The blade member may be formed using at least one of these. Incidentally, in these materials, more preferred are those having a polar group such as a urethane group, an ester group or an amide group. Also, the material (resin composition) for forming the blade member may be any material as long as it can form the blade member that has physical properties required as the stated blade member and may satisfy the prescriptions concerning the surface free energy described previously, and it may optionally contain various additives other than the resin component.

The present inventors have further made studies on the influence exercised by the hardness of the blade member, which have been made in the following way.

Polyester elastomers having Shore D hardness in the range of from 25 degrees to 78 degrees have been formed into developer level control blades, and their durability has been evaluated. As the result, it has come to light that resins higher than 78 degrees, though having kept the external additive from adhering, causes sometimes the toner melt adhesion because of, e.g., crushing of toner base particles. From the foregoing, it has turned out that the hardness of the blade member is concerned sometimes with the toner melt adhesion and that more preferable material hardness must be selected in accordance with developing processes and toner properties.

That is, the blade member may also preferably have a Shore D hardness of from 25 degrees or more to 75 degrees or less from the viewpoint of keeping the toner melt adhesion from occurring. More specifically, as long as its hardness is within this range, the faulty images such as lines can more effectively be kept from occurring because of a large friction between the blade and the developer carrying member or the developer or because of unstable control of the developer level. Also, the friction between the blade and the developer carrying member or the developer can be kept in a good state, and also faulty images such as development lines can more effectively be kept from occurring which are caused by toner melt adhesion due to crushing of the developer or pieces of broken particles during long-term service as a result of the acceleration of deterioration of the developer because of a high hardness of the blade member itself.

The present inventors have concluded that as an elastomer containing a resin having a polar group having the forgoing characteristics a polyester elastomer is preferred, especially the structure material having an aromatic group adjacent to an ester linkage is preferred.

Incidentally, the Shore D hardness of the blade member may be controlled by the mixing proportion of a hard-segment component and a soft-segment component the polyester elastomer has, to achieve the blade member's Shore D hardness that corresponds to development processes as desired.

The blade member is formed of the polyester elastomer, which may preferably be a polyester elastomer, in particular, a thermoplastic polyester elastomer, of a block copolymer constituted of a hard-segment component having an ester linkage adjoining to an aromatic group or the like and a soft-segment component composed of a polyether.

The hard-segment component of the polyester elastomer may preferably include, e.g., phthalic acid, terephthalic acid, isophthalic acid, 2,6-dinaphthalenedicarboxylic acid and p-phenylenedicarboxylic acid. As the soft-segment component, it may preferably include, e.g., ethylene glycol, propylene glycol, 1,4-butanediol, 1,6-hexanediol, neopentyl glycol, diethylene glycol, triethylene glycol, polytetraethylene glycol and polytetramethylene glycol.

Incidentally, a material (resin composition) for forming the blade member may be any material as long as it can form the blade member that has physical properties required as the stated blade member and may satisfy the prescriptions concerning the surface free energy described previously, and it may optionally contain various additives other than the resin component.

As described above, where the developer level control blade has the whole-area laminated structure, the developer level control blade, when pressure touching force is applied, comes into pressure touch with the developer carrying member and thereafter, while deflecting further, presses the developer carrying member. At this point, a repulsion elastic force acts which is due to the developer level control blade. The present inventors consider that the total sum of elastic force of the blade member and that of the support member contributes to the pressure touching force.

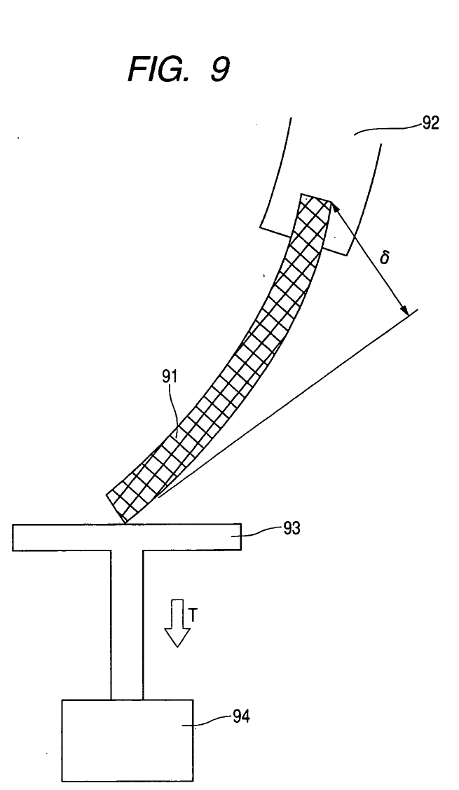

In order to make proper the strength of the touch of the blade with the developer carrying member such as a developing sleeve, it is preferable to analyze the properties of the developer level control blade in the state it is actually used. Accordingly, apparent Young's modulus (Ea) of the developer level control blade is measured with, e.g., an instrument as shown in FIG. 9.

As shown in FIG. 9, a developer level control blade 91 is fastened at its one-side end with a chuck 92 so that the state the blade is fastened to the developer container can be reproduced. At its the other end, it is brought into touch with a stage 93 so that the state the developer level control blade 91 is brought into counter touch with the developer carrying member can be reproduced. Now, the chuck 92 is moved so as to reproduce the state the developer level control blade 91 is disposed in the developing assembly and used, to cause the developer level control blade 91 to bend in a deflection level of δ (mm). Also, a touching force T (kN) applied to the stage is measured with a detector 94. Then, the apparent Young's modulus Ea (kN/mm²) is calculated from the theory of a thin-sheet cantilever spring, on the basis of the values of length (mm) as size in the lengthwise direction, width (mm) and thickness (mm) of the developer level control blade 91 in addition to the deflection level δ (mm) and touching force T (kN).

The apparent Young's modulus Ea (kN/mm²) thus measured is considered to reflect the properties of a developer level control blade held in the state the developer level control blade is actually disposed in the developing assembly. Stated specifically, when measured setting the touching force T at 0.49 N, the apparent Young's modulus Ea may preferably be 140 kN/mm² or more, and more preferably 150 kN/mm² or more, and on the other hand may preferably be 170 kN/mm² or less, and more preferably 160 kN/mm² or less.

As long as the apparent Young's modulus Ea is 140 kN/mm² or more, better triboelectric charging of the developer can be achieved and also any slip-through of the developer can be prevented. Also, as long as the apparent Young's modulus Ea is 170 kN/mm² or less, an appropriate pressure touch of the developer level control blade with the developer carrying member can be achieved, the level of the developer to be transported can be controlled within a suitable range, and high-grade images can be formed. Durability of the developer level control blade and developer carrying member can also be improved.

Incidentally, there are developer (toner) particles between the blade member and the developer carrying member. Where the blade member has a too small thickness, the blade member, which is richer in variability, has a possibility of being forced back. On the other hand, where the blade member has a too large thickness, there is a possibility that any repulsion attributable to the toner particles is so insufficient that any sufficient charging can not be performed. In addition to the thickness of the blade member, the behavior of pressure touch of toner is also influenced by the elasticity of the blade member, the thickness of the support member and the rigidity of the support member. Similarly, the thickness of the developer level control blade (the total thickness in the laminated structure) is also an important factor.

From the foregoing viewpoints, in order to achieve a sufficient function as the blade, the blade member may preferably have a thickness of 1 μm or more, and more preferably 10 μm or more. It may also have a thickness of 50 μm or more, or may have even a thickness of 100 μm or more. On the other hand, in order to achieve appropriate pressure touch, charge the developer particles uniformly and keep the blade member from wearing, the blade member may preferably have a thickness of 300 μm or less, and more preferably 100 μm or less, which may even be 50 μm or less. Also from the like viewpoints, the support member may preferably have a thickness of 50 μm or more, more preferably 80 μm or more, still more preferably 90 μm or more, and most preferably 100 μm or more. On the other hand, it may preferably have a thickness of 150 μm or less. Further from the like viewpoints, the total thickness of the developer level control blade may preferably be the sum of the blade member thickness described above and the support member thickness described above, e.g., preferably from 51 μm or more to 450 μm or less.

The surface roughness of the developer level control blade being in contact with the developer carrying member is determined by the developing process such as toner particle diameters and the surface roughness of the developer carrying member, but the surface roughness is generally not outside the reach of practical use.

As decribed above, the surface of the blade member on the side opposite to the side on which it is to be bonded to the support member is formed as the charge control face, and this surface may preferably have a ten-point average roughness (Rz) of not more than 3.5 μm.

The support member may preferably be made of a metal flat sheet or a resin flat sheet, and stated more specifically a stainless-steel sheet, a phosphor bronze sheet, an aluminum sheet or the like. Also, in order to achieve any desired charging performance and so forth, an additive such as a conductive material may be added to the above chief materials for the blade member. Still also, the support member and the blade member may be joined by, e.g. bonding with an adhesive used in laminating, such as a hot-melt type or a two-part curing type having a urethane group.

The developer level control blade having the above constitution can be manufactured in a good precision and a good productivity by extruding the raw material for the blade member onto a charge control face face-transferring sheet in a uniform thickness, followed by solidification to make a blade member layer; laminating the support member to the surface (the side not serving as the charge control face) of the blade member obtained, to bond them together to form a laminate; and cutting the laminate obtained, to have the peripheral shape of the developer level control blade as a final shape, by means of a press and a cutter or the like. This cutting may preferably be carried out on the side of the face transferring sheet.

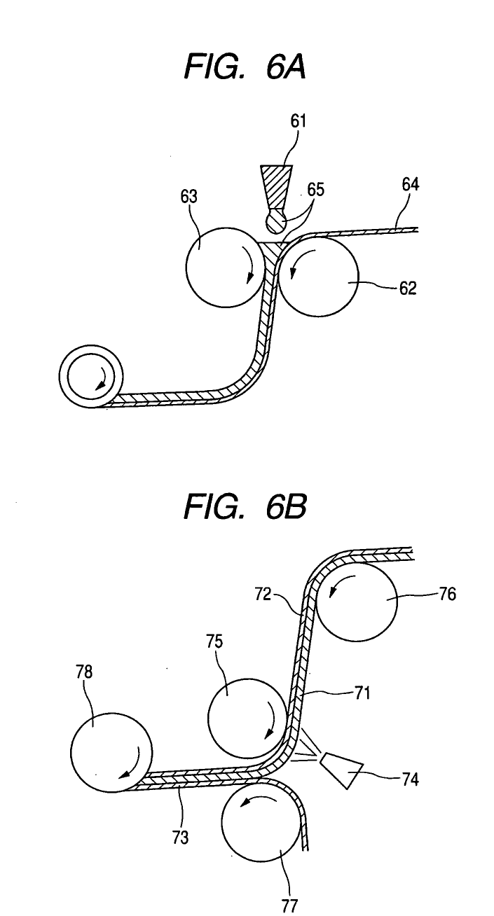

An example of a blade member manufacturing process which utilizes roll coating is shown in FIG. 6A. First, a face transferring sheet 64 is set on a roll 62. A raw material 65 for the blade member is injected and fed from a nozzle 61, and is passed through a gap between rolls 62 and 63 which has been adjusted to a preset space. Thereafter, the raw material 65 is solidified by drying. Thus, a blade member is obtained which has been covered with the face transferring sheet on the former's charge control face side. Here, the surface of the roll 63 positioned on the side of the raw material 65 for the blade member may preferably be a rough surface. More specifically, the surface of the roll on the side opposite to the face transferring sheet and coming into contact with the raw material for the blade member is made rough-surface. In this case, of the both sides of the blade member obtained, the side to which the support member is to be bonded is made rough-surface. As the result, the blade member can have a larger contact area surface on that side, and also, because of an anchor effect, a great adhesive force can be obtained between the blade member and the support member. From such a viewpoint, the rough surface may preferably have a ten-point average roughness (Rz) of 1.5 μm or more.

The rough surface of the roll surface may be formed by embossing with a pattern of various types, or by scratch patterning. Such a roll surface may be obtained by etching or mechanical surface-roughing. Incidentally, it is preferable to avoid any roll surface-roughing that may affect the surface properties of the blade member on the side of the face transferring sheet (charge control face), and the rough surface may preferably have a ten-point average roughness (Rz) of 5.0 μm or less.

Such a rough-surface roll need not necessarily be metallic, and any heat-resistant material may suffice. For example, it is effective to use a silicone rubber roll subjected to surface-roughing treatment. A ceramic material may also be used, which may be provided with a reinforcing coating on its surface if there is concern about brittleness.

Incidentally, the blade member and the support member which have been bonded together may thereafter be heated to achieve much higher adherence.

As the face transferring sheet, a film formed of a polyester resin, a polyamide resin, a polyolefin resin, a copolymer of any of these or an alloy of any of these may be used. In particular, a film formed of at least one selected from polyethylene terephthalate, polyethylene-2,6-naphthalate and a copolymer or composite of these is preferred.

To the blade member thus obtained, after an adhesive coating has been formed on its surface opposite to the side covered with the face transferring sheet, the support member is bonded to make up a laminated structure. Then, the laminate thus obtained is cut into a stated shape by, e.g., press cutting.

Incidentally, the blade member and the support member may also continuously be bonded together by means of an apparatus as shown in FIG. 6B. More specifically, a multi-layer sheet consisting of a blade member 71 and a face transferring sheet 72 is fed to a roll 75 via a roll 76, and an adhesive is coated by a spray coater 74 on the blade member 71 on its side to which the support member is to be bonded. Thereafter, feeding a support member 73 through a roll 77, the support member 73 is bonded to the blade member 71, and the laminate thus obtained is wound up on a roll 78.

In the manufacturing process described above, as being different from blade members formed in a mold or the like, the raw material for the blade member is accumulated on the face transferring sheet, and the face of the face transferring sheet is replicated to the blade member. In the case when a mold face is replicated, the surface is brought into a mirror face by, e.g., polishing and buffing. It, however, may be necessary to go through many steps until the presence of any microscopic unevenness and grooves or the like have come to be of no problem. In contrast thereto, in the case of the face transferring sheet, the flatness (as Rz, preferably 3.5 μm or less, more preferably 1.0 μm or less, and still more preferably 0.3 μm or less) necessary for the charge control face can be achieved with ease. As the result, the developer level control blade can be manufactured in a good precision and good productivity.

For fine structure of the charge control face, it is also important to be smooth. Even if its roughness is measured as a relatively large numerical value in a macroscopic view, the charge control face may suffice as long as it is smooth in a microscopic view. More specifically, even if it has a roughness of 2 to 4 μm, a satisfactory effect is expected under a roughness profile having a relatively large amplitude, as long as it has a roughness of 0.5 μm or less, preferably 0.4 μm or less, and more preferably 0.3 μm or less, in its fine structure.

As another developer level control blade manufacturing process of the present invention, the developer level control blade can be manufactured in a good precision and a good productivity by a manufacturing process having the step of co-extruding a molten resin material for forming a charge control face face-transferring sheet and a molten resin material for forming a blade member; the step of shaping the resultant extruded product into a cylindrical form by multi-layer blown-film extrusion to obtain a cylindrical product; the step of cutting the resultant cylindrical product in parallel to the direction of extrusion to form at least one multi-layer sheet; the step of laminating the support member to the multi-layer sheet on its side having the blade member, to bond them together to form a laminate; and the step of cutting the resultant laminate to have the peripheral shape of the developer level control blade as a final shape. This cutting may preferably be carried out on the side of the face transferring sheet.

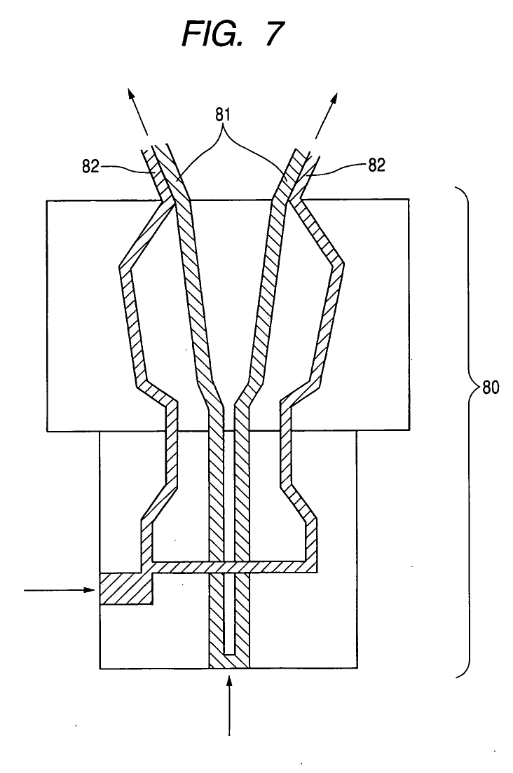

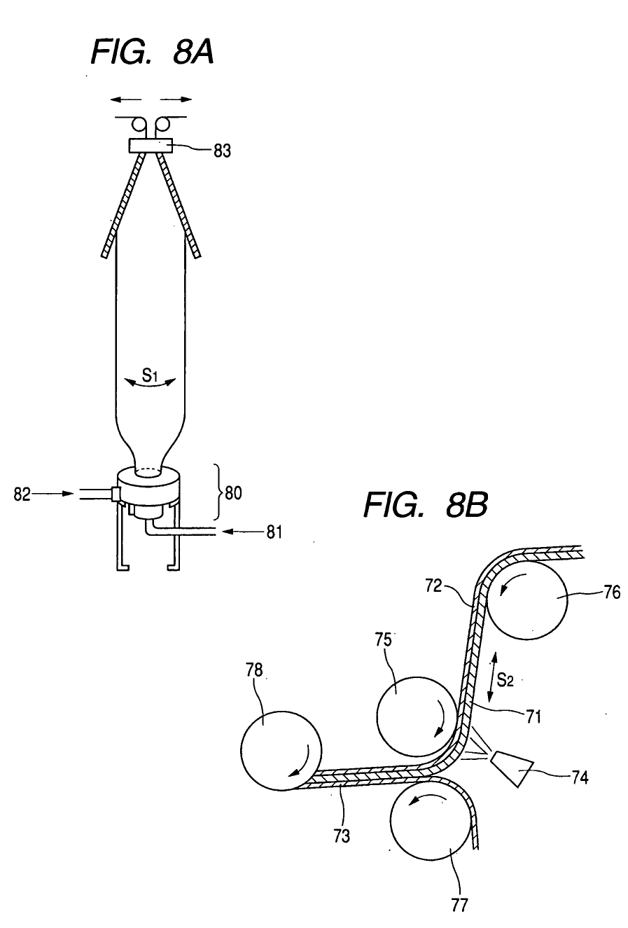

For example, as shown in FIG. 7, a face transferring sheet forming molten resin 82 and a blade member forming molten resin 81 are co-extruded from a circular die 80 in a cylindrical shape. Thereafter, as shown in FIG. 8A, air is blown into the cylindrical extruded product to blow up the same, which is then drawn up closing its upper part and then, e.g., cut with a cutter 83 into two sheets to obtain multi-layer sheets. Here, it is preferable for the cylindrical product to be so formed that its outer layer is the face transferring sheet.

The blade member (layer) of each multi-layer sheet thus obtained and the support member (layer) may continuously be bonded together by means of an apparatus as shown in FIG. 8B. More specifically, a multi-layer sheet consisting of a blade member 71 and a face transferring sheet 72 is fed to a roll 75 via a roll 76, and an adhesive is coated by a spray coater 74 on the blade member 71 on its side to which the support member is to be bonded. Thereafter, feeding a support member 73 through a roll 77, the support member 73 is bonded to the blade member 71, and the laminate thus obtained is wound up on a roll 78.

Incidentally, the method utilizing the multi-layer blown-film extrusion as described above is effective where a thin face transferring sheet and a thin blade member must be used and any developer level control blade can not be manufactured by the method in which the face transferring sheet and the blade member are individually prepared and then laminated. The use of the thin face transferring sheet and thin blade member enables reduction of manufacturing cost.

Stated specifically, the face transferring sheet may preferably have a thickness of 1 μm or more, more preferably 10 μm or more, and still more preferably 50 μm or more, and on the other hand preferably a thickness of 200 μm or less. Also, the blade member may preferably have a thickness of 1 μm or more, and more preferably 10 μm or more, which may have even a thickness of 50 μm or more, and on the other hand may preferably have a thickness of 100 μm or less, and more preferably 50 μm or less.

The thickness of the multi-layer sheet (the total thickness of the transfer sheet and blade member layer) may preferably be the sum of the face transferring sheet thickness as described above and the blade member thickness as described above, e.g., preferably from 2 μm or more to 300 μm or less.

Incidentally, in the case when the multi-layer blown-film extrusion is employed, as being different from the roll coating, the blade member forming molten resin comes into contact with not the face transferring sheet itself but the face transferring sheet forming molten resin. In this case, when the blade member forming molten resin solidifies to come to the blade member, the face transferring sheet forming molten resin also solidifies. It, however, is considered that the necessary flatness of the charge control face of the blade member can be achieved by the action of a face transferring sheet standing semi-molten. In the case of the multi-layer blown-film extrusion, too, the flatness (as Rz, preferably 3.5 μm or less, more preferably 1.0 μm or less, and still more preferably 0.3 μm or less) necessary for the charge control face can be achieved with ease.

For fine structure of the charge control face, it is also important to be smooth. Even if its roughness is measured as a relatively large numerical value in a macroscopic view, the charge control face may suffice as long as it is smooth in a microscopic view. More specifically, even if it has a roughness of 2 to 4 μm, a satisfactory effect is expected under a roughness profile having a relatively large amplitude, as long as it has a roughness of 0.5 μm or less, preferably 0.4 μm or less, and more preferably 0.3 μm or less, in its fine structure.

The face transferring sheet is peeled before the developer level control blade is used, and hence it is preferable for the face transferring sheet and the blade member to have good releasability. From such a viewpoint, the resin component for the face transferring sheet may preferably be a straight-chain high polymer not containing any polar group, and the resin contained in the resin material for the blade member may preferably be a high polymer containing a polar group. As the straight-chain high polymer not containing any polar group, an olefinic high polymer is preferred. As the high polymer containing a polar group, preferred are, but by no means particularly limited to, a polyester type high polymer, a polyamide type high polymer and a polyurethane type high polymer.

In order to improve the releasability of the face transferring sheet and blade member, a tack reducing agent such as air, an inert gas or a gas containing tack-free fine particles may further be ejected to the space between the face transferring sheet forming molten resin and the blade member forming molten resin when the face transferring sheet forming molten resin and the blade member forming molten resin are co-extruded from the circular die, as long as the effect attributable to the face transferring sheet does not come insufficient.

When the laminate consisting of the face transferring sheet, the blade member and the support member, prepared as described above, is cut to have the shape of the developer level control blade, it may preferably be so cut that, as shown in FIG. 3C, orientation direction SD of the blade member resin (resin for the blade member) falls substantially at right angles with lengthwise direction LD of the blade member. In this case, the bond strength of the blade member and support member can be improved. The blade member resin may be oriented by inflating the cylindrical product sufficiently after the face transferring sheet forming molten resin and the blade member forming molten resin have been co-extruded from the circular die. In this case, the orientation direction of the resin is frost line direction S1 as shown in FIG. 8A. Accordingly, the cutting in the shape of the developer level control blade is so carried out that the lengthwise direction of the developer level control blade obtained is in parallel to the direction of making the laminate (i.e., extrusion direction).

The blade member resin may also be oriented by stretching the multi-layer sheet sufficiently after the multi-layer sheet has been formed. In this case, the orientation direction of the resin is orientation direction S2 as shown in FIG. 8B. Accordingly, the cutting in the shape of the developer level control blade is so carried out that the lengthwise direction of the developer level control blade obtained falls at right angles with the direction of making the laminate (i.e., stretch direction).

Incidentally, before the support member layer is laminated to the blade member layer surface of the multi-layer sheet, the blade member layer may be made rough-surface on its side to which the support member layer is to be bonded. This enables improvement in adherence between the blade member and the support member. For example, the surface of the roll 76 coming into contact with the blade member 71 shown in FIG. 8B is made rough-surface, whereby the blade member can be made rough-surface. In this case, the blade member can have a larger contact area surface on that side, and also, because of an anchor effect, a great adhesive force can be obtained between the blade member and the support member. From such a viewpoint, the rough surface may preferably have a ten-point average roughness (Rz) of 1.5 μm or more.

The rough surface of that roll surface may be formed by embossing with a pattern of various types, or by scratch patterning. Such a surface may be obtained by etching or mechanical surface-roughing. Also, it is preferable to avoid any surface-roughing that may affect the surface properties of the blade member on the side of the face transferring sheet (charge control face), and the rough surface may preferably have a ten-point average roughness (Rz) of 5.0 μm or less.

Such a rough-surface roll need not necessarily be metallic, and any heat-resistant material may suffice. For example, it is effective to use a silicone rubber roll subjected to surface-roughing treatment. A ceramic material may also be used, which may be provided with a reinforcing coating on its surface if there is concern about brittleness.

Incidentally, the blade member and the support member which have been bonded together may be heated to achieve much higher adherence.

The face transferring sheet of the developer level control blade thus manufactured may preferably not be peeled just until the developer level control blade is attached to the preset position of the developing assembly, in order that the developer level control blade covered with the face transferring sheet can be stored and transported as a component part (a stock). This is because, here, the face transferring sheet does a part as a protective sheet of the developer level control blade as it is.

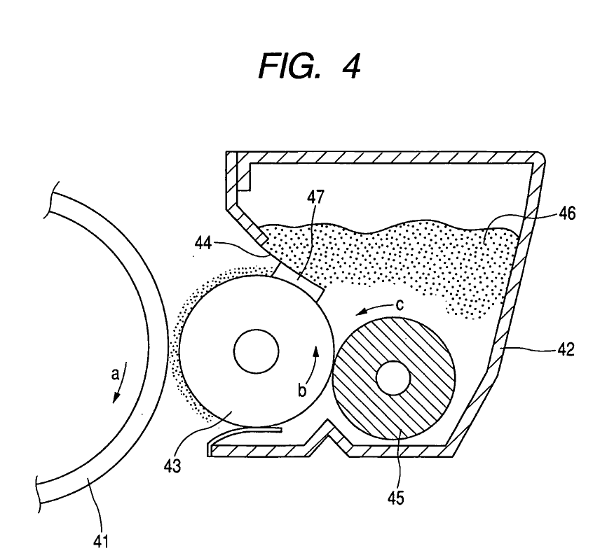

An example of a developing assembly making use of the developer level control blade according to the present invention is shown in FIG. 4. Reference numeral 42 denotes a developer container holding therein, e.g., a one-component developer 46. This developing assembly has, inside the developer container 42, a developing sleeve serving as a developer carrying member 43 which is provided opposingly to an image-bearing member electrophotographic photosensitive member 41 rotatable in the direction of an arrow a shown in the drawing and develops an electrostatic latent image on the electrophotographic photosensitive member 41 to render it visible as a toner image. The developer carrying member 43 is rotatably laterally provided in such a way that it is thrust into the developer container 42 by substantially the right half of its peripheral surface as viewed in the drawing, and is exposed to the outside of the developer container 42 by substantially the left half of its peripheral surface. A minute gap is provided between the developer carrying member 43 and the electrophotographic photosensitive member 41. The developer carrying member 43 is rotated in the direction of an arrow b against the rotational direction a of the electrophotographic photosensitive member 41.

Inside the developer container 42, a developer level control blade 44 according to the present invention is provided at the upper position of the developer carrying member (developing sleeve) 43. An elastic roller 45 is also provided at the position on the side upstream to a blade member 30, of the rotational direction of the developing sleeve 43. The developer level control blade 44 is provided obliquely in the downward direction toward the upstream side of the rotational direction of the developing sleeve 43, and is brought into touch with the upper peripheral surface of the developing sleeve 43 against its rotational direction. The elastic roller 45 is provided in contact with the developing sleeve 43 at its part opposite to the electrophotographic photosensitive member 41, and is rotatably supported.

In the developing assembly constructed as described above, the elastic roller 45 is rotated in the direction of an arrow c to carry a toner 46 and feed it to the vicinity of the developing sleeve 43 as the elastic roller 45 is rotated. The toner 46 carried on the elastic roller 45 is caused to rub against the surface of the developing sleeve 43 at a touching zone (nip) where the developing sleeve 43 and the elastic roller 45 come into touch, so that the toner adheres to the surface of the developing sleeve 43.

Thereafter, with the rotation of the developing sleeve 43, the toner 46 having adhered to the surface of the developing sleeve 43 reaches the touching zone between the developer level control blade 44 and the developing sleeve 43 to come held between them, and is rubbed with both the surface of the developing sleeve 43 and a blade member 47 of the developer level control blade 44 when passed there, so that the toner is sufficiently triboelectrically charged.

The toner 46 thus charged gets away from the touching zone between the blade member 47 and the developing sleeve 43, so that a thin layer of the toner is formed on the developing sleeve 43, and is transported to the developing zone where the sleeve 43 faces the electrophotographic photosensitive member 41 leaving a minute gap. Then, at the developing zone and across the developing sleeve 43 and the electrophotographic photosensitive member 41, for example an alternating voltage formed by superimposing an alternating current on a direct current is applied as a development bias, whereupon the toner 46 carried on the developing sleeve 43 is transferred to the electrophotographic photosensitive member 41 correspondingly to the electrostatic latent image formed thereon, to adhere to the electrostatic latent image to develop it, so that it is rendered visible as a toner image.

The toner 46 not consumed in the development at the developing zone and having remained on the developing sleeve 43 is collected into the developer container 42 at the lower part of the developing sleeve 43 as the developing sleeve 43 is rotated. The toner 46 collected is scraped off by the elastic roller 45 from the surface of the developing sleeve 43 at the contact zone between the elastic roller 45 and the developing sleeve 43. At the same time, as the elastic roller 45 is rotated, the toner 46 is anew fed onto the developing sleeve 43, and the new toner 46 is again transported to the touching zone between the developing sleeve 43 and the blade member 47.

Meanwhile, the greater part of the toner 46 scraped off is, as the elastic roller 45 is rotated, mutually mixed with the toner 46 remaining in the developer container 42, where the triboelectric charges of the toner scraped off are dispersed.

As the developer level control blade 44, the blade according to the present invention (e.g., the blade having the structure shown in FIG. 3), in which the blade member and the blade member are so laminated that their peripheral shapes are in agreement with each other, may be used to obtain the developing assembly according to the present invention.

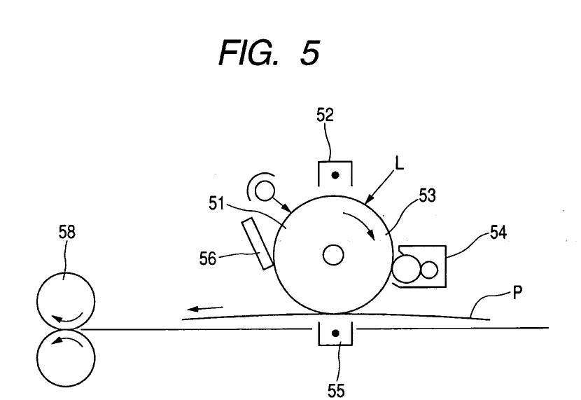

An example of an electrophotographic apparatus suited for employing the developing assembly of the present invention is shown in FIG. 5. Reference numeral 51 denotes a photosensitive member serving as an image bearing member. What is used in this example is a drum type electrophotographic photosensitive member constituted basically of a conductive support made of aluminum or the like and a photosensitive layer formed on its peripheral surface. It is rotatingly driven around an axis in the clockwise direction as viewed in the drawing, and at a stated peripheral speed.

A charging member 52 is a corona charging assembly which is in contact with the surface of the photosensitive member 51 and primarily uniformly charges the photosensitive member surface to stated polarity and potential. This may also be a charging roller. The surface of the photosensitive member 51 thus charged uniformly by the charging member 52 is then exposed to light of intended image information by an exposure means L (laser beam scanning exposure or original-image slit exposure), whereupon electrostatic latent images 53 corresponding to the intended image information are formed on the peripheral surface of the photosensitive member.

The electrostatic latent images thus formed are successively rendered visible as toner images by means of a developing assembly 54. The toner images thus formed are then successively transferred by the operation of a transfer means 55, to the surface of a transfer material P fed from a paper feed means section (not shown) to a transfer zone between the photosensitive member 51 and the transfer means 55 in the manner synchronized with the rotation of the photosensitive member 51 and at proper timing.

The transfer means 55 in this example is a corona discharger (or may be of a roller type), which charges the transfer material P on its back to a polarity reverse to that of the toner, whereupon the toner images on the side of the photosensitive member 51 surface are transferred on to the surface of the transfer material P. Also, in a color LBP (laser beam printer) or the like which reproduces color images using four color toners, in order to develop four color latent images individually to render them visible, toner images are first transferred to an intermediate transfer member such as a roller or a belt, and then the toner images are transferred on to the surface of the transfer material P.

The transfer material P to which the toner images have been transferred is separated from the surface of the photosensitive member 51, forwarded to heat fixing rolls 58, where the toner images are fixed, and then put out of the apparatus as an image-formed material. The surface of the photosensitive member 51 from which toner images have been transferred is brought to removal of adherent contaminants such as transfer residual toners, through a cleaning means 56. Thus the photosensitive member is cleaned on its surface, and then repeatedly used for the formation of images.

Incidentally, a plurality of components of the electrophotographic apparatus, such as the photosensitive member, the charging member, the developing assembly and the cleaning means, may integrally be incorporated in a process cartridge so that the process cartridge is detachably mountable to the main body of the electrophotographic apparatus. For example, the photosensitive member and the developing assembly, optionally together with the charging member and the cleaning means, may integrally be incorporated in a process cartridge so as to be detachably mountable through a guide means such as rails provided in the main body of the apparatus.

The electrophotographic apparatus in which the developing assembly having the developer level control blade according to the present invention is usable may include copying machines, laser beam printers, LED printers, and apparatus where electrophotography is applied, such as electrophotographic platemaking.

### EXAMPLES

The present invention is described below in greater detail by giving Examples and Comparative Examples. In the following, unless particularly noted, “part(s)” and “%” refer to “part(s) by weight” and “% by weight”, respectively. As reagents and so forth, commercially available high-purity products are used.

### Example 1

As a raw material for the blade member, a polyester elastomer (trade name: PELPRENE P40H; available from Toyobo Co., Ltd.) was melted at 250° C. The molten product obtained was so extruded onto a face transferring sheet (polypropylene film of 0.1 mm in thickness and 0.3 μm in surface roughness Rz, produced by extrusion) that its thickness came to 0.12 mm after solidifying, and a double-layer sheet of 0.22 mm in total thickness of the both was produced by roll coating. The double-layer sheet thus obtained was bonded to a phosphor bronze sheet of 0.12 mm in thickness as a blade member, having a spring elasticity, followed by cutting in a shape of 200 mm in length as size in the lengthwise direction and 22 mm in width. Thereafter, the face-transferring sheet was peeled from the blade of the laminated sheet to obtain a developer level control blade.

Next, to measure the surface free energy of the charge control face, the blade member was left in an environment of 23° C./55% RH for a day. Thereafter, using a contact angle meter manufactured by Kyowa Kaimen Kagaku K.K. (trade name: CA-X), water, diiodomethane and ethylene glycol three liquids were dropped on the charge control face of the blade member and their contact angles were directly read. From the contact angles of these liquids, the surface free energy consisting of the dispersion component, the bipolar component and the hydrogen bond component was calculated.

Charge quantity (triboelectricity) of the toner was also measured. As a method of evaluating the triboelectric charging ability of the charge control face of the developer level control blade, the following method was employed. The developer level control blade and the developing sleeve were fitted to the developing assembly and the developing sleeve was rotated to transport the toner, the developer held in the developer container. The toner was provided with electric charges by triboelectric charging with the developer level control blade, and the toner having electric charges was uniformly coated on the developing sleeve. From the values of charge quantity (Q) and mass (M) found by suction of this toner, toner charge quantity per unit mass, Q/M (μC/g), was calculated.

This toner charge quantity Q/M is suited for evaluating the triboelectric charging ability because a difference in numerical values is produced depending on the triboelectric charging performance of the charge control face of the developer level control blade.

The developing assembly thus set up was fitted to a laser beam printer (trade name: LASER SHOT; manufactured by CANON INC.) in a low-temperature and low-humidity environment of 15° C./10% RH to make running evaluation where images were formed on 50 K (K=1,000) sheets, in which whether or not any vertical lines appeared in the images was examined at intervals of 1 K and further whether or not any toner melt adhesion matter was present on the blade surface was examined at intervals of 10 K, to make evaluation.

The results were evaluated according to four ranks: good (AA), in which no vertical line appeared in images and no toner melt adhesion matter was present; rather good (A), in which vertical line appeared in solid black images but no vertical line appeared in halftone images, and toner melt adhesion matter was present which was so slight as to not be able to be seen in images; average (B), in which vertical lines were observable in both solid black images and halftone images, and toner melt adhesion matter was present; and poor (C), in which vertical lines were observable in both halftone images and solid black images, and toner melt adhesion matter was present in a large quantity. The results are shown in Table 1.

### Example 2

A developer level control blade was produced in the same manner as in Example 1 except that a polyamide elastomer (trade name: DAIAMID PAE E47S3; available from Daicel-Degussa Ltd.) was used as a raw material for the blade member. Evaluation was made in the same manner as in Example 1. The results are shown in Table 1.

### Examples 3 & 4

Developer level control blades were produced in the same manner as in Example 1 except that polyurethane elastomers (trade name: PANDEX T-1190; available from DIC Bayer Polymer Ltd.) (Example 3) and (trade name: PANDEX T-8190; available from DIC Bayer Polymer Ltd.) (Example 4) were used as raw materials for the blade members. Evaluation was made in the same manner as in Example 1. The results are shown in Table 1.

### Example 5

A developer level control blade was produced in the same manner as in Example 1 except that a polyester elastomer (trade name: HYTREL 4777; available from Du Pont-Toray Co., Ltd.) was used as the raw material for the blade member. Evaluation was made in the same manner as in Example 1. The results are shown in Table 1.

### Comparative Example 1

A developer level control blade was produced in the same manner as in Example 1 except that a polyurethane elastomer (trade name: PANDEX T-2190; available from DIC Bayer Polymer Ltd.) was used as a raw material for the blade member. Evaluation was made in the same manner as in Example 1. The results are shown in Table 1.

### Comparative Example 2

The developer level control blade produced in Example 2 was dip coated with a urethane coating agent (trade name: WS-4000; available from Takeda Chemical Industries, Ltd.) as a surface modifying material, followed by drying to harden in a 110° C. drying furnace. Here, the coating layer formed was 5 μm in thickness. This developer level control blade was evaluated in the same manner as in Example 1. The results are shown in Table 1.

TABLE 1

| | | | | | | Comparative | |
|---|---|---|---|---|---|---|---|
| Evaluation | Example | | | | | Example | |
| items | 1 | 2 | 3 | 4 | 5 | 1 | 2 |
| Surface free energy: (mN/m) | | | | | | | |
| Dispersion component (γsd) | 34 | 31 | 27 | 32 | 31 | 28 | 15 |
| Bipolar component (γsp) | 26 | 25 | 35 | 27 | 30 | 50 | 80 |
| Hydrogen bond component (γsh) | 3 | 5 | 3 | 3 | 3 | 6 | 15 |
| Surface free energy (γs) | 63 | 61 | 65 | 62 | 64 | 64 | 110 |
| Image evaluation: | | | | | | | |
| In solid black, vertical lines occur on Kth sheet | None | None | 46K | None | 44K | 30K | 10K |
| In halftone, vertical lines occur on Kth sheet | None | None | None | None | None | 39K | 23K |
| Toner melt adhesion matter: | None | None | Stly | None | Stly | Present | Present |
| | | | present | | present | | Large |
| Toner triboelectricity (Q/M): (μC/g) | −23 | −24 | −22 | −24 | −23 | −22 | −22 |
| Overall evaluation: | AA | AA | A | AA | A | B | C |

Stly: Slightly

It is seen from the results in Table 1 that, in the cases of blade members having a high surface free energy and also a bipolar component of more than 35 as in Comparative Examples 1 and 2, the external additive has adhered in a large quantity in the first half of the running test and the toner melt adhesion has occurred. As their extent, the higher the surface free energy the charge control face of the blade member has and also the larger the bipolar component thereof is, the more attendantly the toner melt adhesion matter deposits at the touching zone between the developer level control blade and the developing sleeve or developing roller to more cause vertical lines in images.

On the other hand, blade members having a low surface free energy and also having small bipolar component and hydrogen bond component as in Examples 1 to 5 cause no or only slight toner melt adhesion and cause no or substantially no vertical lines in images to obtain good results. In the criteria, good is used in the case of no practical problem even if small amount of toner melt adhesion are appeared.

Next, the working examples which forcuses attention on hardness influences are explained.

### Example 6

As a raw material for the blade member, a polyester elastomer (trade name: HYTREL 4047; available from Du Pont-Toray Co., Ltd.) was melted at 250° C. The molten product obtained was so extruded onto a face transferring sheet (polyethylene terephthalate film of 0.1 mm in thickness and 0.2 μm in surface roughness Rz, produced by extrusion) that its thickness came to 0.1 mm after solidifying, and a sheetlike laminate of 0.4 mm in total thickness of the both was produced by roll coating.

To this sheetlike laminate, a phosphor bronze sheet as a support member, of 0.12 mm in sheet thickness was bonded providing between them an adhesive layer composed of ADCOAT AD-76P1 (trade name), available from Toyo Moton Co., and the resultant laminate was press-cut in a prescribed blade size to produce a developer level control blade. Here, the developer level control blade was 200 mm in length as size in the lengthwise direction and 23 mm in width.

The face transferring sheet was peeled and the surface roughness Rz (ten-point average roughness) of the charge control face of the blade member before use was also measured with SURFCORDER SE3500 (trade name), manufactured by Kosaka Laboratory Ltd., to find that it was 0.2 μm.

Next, to measure the surface free energy of the charge control face, the face transferring sheet was peeled, and the blade member was left in an environment of 23° C./55% RH for a day. Thereafter, using a contact angle meter manufactured by Kyowa Kaimen Kagaku K.K. (trade name: CA-X), water, diiodomethane and ethylene glycol three liquids were dropped on the charge control face of the blade member and their contact angles were directly read. From the contact angles of these liquids, the surface free energy consisting of the dispersion component, the bipolar component and the hydrogen bond component was calculated.

The developer level control blade thus produced and a developing sleeve obtained by blasting an aluminum pipe to have a ten-point average roughness Rz of 2.5 μm were so fitted to a developing assembly that the pressure touch between the developer level control blade and the developing sleeve was at a pressure of 0.18 N/cm. To the developer container, a sponge roller made of foamed urethane was fitted as an elastic roller which coats a toner on the developing sleeve and also acts to scrape off any toner having remained without participating in development and return it again to the developer container. A non-magnetic toner was put into the developer container.

The developing assembly thus set up was fitted to a laser beam printer (trade name: LASER SHOT; manufactured by CANON INC.) in a low-temperature and low-humidity environment of 30° C./85% RH and the developing sleeve was driven, where the state of coating of the toner on the developing sleeve was observed to visually examine whether or not any lines or non-uniform images were seen. Evaluation was made according to three ranks: good (A), rather good (B) and poor (C).

Subsequently, evaluation was made on 50 K (K=1,000) sheet running to ascertain whether or not any vertical lines due to toner melt adhesion appeared. The results were evaluated according to three ranks: good (A), in which no vertical line appeared in both two patterns of solid black and halftone; rather good (B), in which no vertical line appeared in the halftone pattern but appeared in the solid-black pattern; and poor (C), in which vertical lines were observable in both patterns of solid black and halftone.

Charge quantity (triboelectricity) of the toner was also measured. As a method of evaluating the triboelectric charging ability of the charge control face of the developer level control blade, the following method was employed. The developer level control blade and the developing sleeve were fitted to the developing assembly and the developing sleeve was rotated to transport the toner, the developer held in the developer container. The toner was provided with electric charges by triboelectric charging with the developer level control blade, and the toner having electric charges was uniformly coated on the developing sleeve. From the values of charge quantity (Q) and mass (M) found by suction of this toner, toner charge quantity per unit mass, Q/M (μC/g), was calculated.

This toner charge quantity Q/M is suited for evaluating the triboelectric charging ability because a difference in numerical values is produced depending on the triboelectric charging performance of the charge control face of the developer level control blade.

Image density of solid black images reproduced on paper by the use of a non-magnetic black toner was further measured with a Macbeth densitometer as solid-black density.

In addition, the stability and mass productivity of the developer level control blade were evaluated according to three ranks: good (A), in which the yield in production steps was good and also continuous workability was good; rather good (B); and poor (C).

The results are shown in Table 2.

### Examples 7 to 10

Developer level control blades were produced in the same manner as in Example 6 except that polyester elastomers having a Shore D hardness of 25 degrees (trade name: HYTREL 3046; available from Du Pont-Toray Co., Ltd.) (Example 7), 55 degrees (trade name: HYTREL 5557; available from Du Pont-Toray Co., Ltd.) (Example 8), 75 degrees (trade name: HYTREL 2751; available from Du Pont-Toray Co., Ltd.) (Example 9) and 78 degrees (trade name: PELPRENE E-450B; available from Toyobo Co., Ltd.) (Example 10) were used as raw materials for blade members; also except that in Example 7 the support member was in a thickness of 0.15 mm.

Evaluation was made in the same manner as in Example 6. The results are shown in Table 2.

TABLE 2

| | Example | | | | |
|---|---|---|---|---|---|
| | 6 | 7 | 8 | 9 | 10 |
| Blade member thickness: (mm) | 0.1 | 0.1 | 0.1 | 0.1 | 0.1 |
| Shore D hardness: (degree) | 40 | 25 | 55 | 75 | 78 |
| Surface free energy: (mN/m) | | | | | |
| Dispersion component (γsd) | 33 | 31 | 32 | 33 | 32 |
| Bipolar component (γsp) | 22 | 26 | 25 | 21 | 23 |
| Hydrogen bond component (γsh) | 3 | 4 | 2 | 2 | 2 |
| Surface free energy (γs) | 58 | 61 | 59 | 56 | 57 |
| Support member thickness: (mm) | 0.12 | 0.15 | 0.12 | 0.12 | 0.12 |
| Charge control face surface | 0.2 | 0.2 | 0.2 | 0.2 | 0.2 |
| roughness Rz: (μm) | | | | | |
| Triboelectricity: (μC/g) | −23 | −23 | −22 | −21 | −22 |
| State of coating: | A | A | A | A | B |
| Solid-black density: | 1.4 | 1.5 | 1.5 | 1.4 | 1.5 |
| Vertical lines after 50K running: | A | A | A | A | B |
| Stability & mass productivity: | A | A | A | A | B |

As is evident from Table 2, it has been found that the use of the developer level control blade in which the polyester elastomer of from 40 to 78 degrees (more preferably from 40 to 75 degrees in Shore D hardness is used as the raw material for the blade member and the support member is laminated thereto over the whole area brings good results on all the triboelectricity, the state of coating, the solid-black density and the stability and mass productivity. From these results, it has been found that the blade member wears uniformly and its touch pressure can be controlled in a good precision to achieve a proper pressure against toner particles. Also, the use of a developer level control blade produced in the same manner as in Example 6 except that the blade member is in a thickness of 30 μm has enabled achievement of performance which is equal to or higher than that in Example 6. It has further been conformable that the toner melt adhesion can be kept from occurring, and it has been achievable to provide a high-function developer level control blade adaptable to high-speed and high-durable developing processes.

Next, the working examples which forcuses attention on the influences of a shape and charge control face are explained.

### Examples 11 and 12

Developer level control blades were produced in the same manner as in Example 6 except that polypropylene films of 0.1 mm in thickness and 0.5 μm in surface roughness Rz (Example 11) and polyethylene terephthalate film of 0.12 mm in thickness and 4.0 μm in surface roughness Rz (Example 12) were used as face transferring sheets. Evaluation was made in the same way. The results are shown in Table 3.

### Comparative Example 3

Developer level control blades were produced in the same manner as in Example 6 except that polyethylene terephthalate film of 0.1 mm in thickness and 3.6 μm in surface roughness Rz were used as face transferring sheets. Evaluation was made in the same way. The results are shown in Table 3.

### Comparative Example 4

As a material for blade member the material used in Example 6 was injection-molded at 250° C. to prepare a blade member of 250 mm in length as size in the lengthwise direction, 5 mm in width and 0.9 mm in thickness. Incidentally, the mold used had inner surfaces having been finished to have mirror surfaces, and the mold temperature was set to 40° C. The charge control face of the blade member obtained was 1.0 μm in surface roughness Rz. Thereafter, the blade member obtained was bonded to an end portion of of a support member formed of a phosphor bronze sheet (length as size in the lengthwise direction: 200 mm; width: 22 mm; sheet thickness: 0.12 mm) having a spring elasticity to produce a developer level control blade having the structure as shown in FIG. 2A. Evaluation was made in the same manner as in Example 6. The results are shown in Table 3.

In Comparative Examples 3 and 4, the samples were the same as Example 6, but as to the value of the surface energy, the values few deviated from the desired value were used, and the influence to the performance as the developer level control blade of the present invention depending from the large or small of the surface roughness Rz of the charge control face was observed.

The durability, stability and mass productivity of the developer level control blade are evaluated as 3 ranks: A, in which yield in the production process is good and continuous prosessing is good; B, in which no practical problem but poor yield of the good product; and C, in which no good.

TABLE 3

| | | | Comparative | |
|---|---|---|---|---|
| | Example | | Example | |
| | 11 | 12 | 3 | 4 |
| Surface roughness Rz: | 1.0 | 4.0 | 3.6 | 1.0 |
| (μm) | | | | |
| Surface free energy: (mN/m) | | | | |
| Dispersion component (γsd) | 33 | 34 | 33 | 32 |
| Bipolar component (γsp) | 22 | 23 | 21 | 22 |
| Hydrogen bond component (γsh) | 3 | 3 | 6 | 7 |
| Surface free energy (γs) | 58 | 60 | 60 | 60 |
| Triboelectricity: | −23 | −24 | −22 | −25 |
| (μC/g) | | | | |
| State of coating: | A | A | B | B |
| Solid-black density: | 1.4 | 1.3 | 1.2 | 1.2 |
| Vertical lines after 50K running: | A | B | C | B |
| Stability & mass productivity: | A | B | C | C |

As is evident from Table 3, it has been found that, in the case when the surface roughness is more than 3.5 μm, vertical lines after 50K running tends to become bad in accordance with large roughness of the surface roughness even thoug no practical problem, therefore, the surface roughness Rz of the charge control surface is controlled to be not more than 3.5 μm to provide stable images. It has also found that the shape of the developer level control blade influences the performance of the developer level control blade without influencing the practical images. Also, where the blade member was formed in a thickness of 30 μm, the blade was able to be more improved in its performance.

Next, the working examples which forcuses attention on the influences of the surface roughness between the support member and the face to be adhered of the blade member are explained.

### Examples 13 to 15

As a raw material for the blade member, a polyester elastomer (trade name: HYTREL 4047; available from Du Pont-Toray Co., Ltd.) was melted at 250° C. The molten product obtained was so extruded onto face transferring sheets (polypropylene films of 0.1 mm in thickness and 0.2 μm in surface roughness Rz, produced by extrusion) that their thickness came to 0.15 mm after solidifying, and sheetlike laminates of 0.25 mm in total thickness of the both were produced by roll coating. Here, as rolls with which the polyester elastomer was to come into contact, rolls having a surface roughness Rz of 1.5 μm (Example 13), 3.0 μm (Example 14) and 5.0 μm (Example 15) were used. As the result, the polyester elastomer layers of the sheetlike laminates obtained had a surface roughness Rz of 1.0 μm (Example 13), 2.5 μm (Example 14) and 4.0 μm (Example 15).

To each of these sheetlike laminates, a phosphor bronze sheet of 0.15 mm in sheet thickness was bonded providing between them an adhesive layer composed of ADCOAT AD-76P1 (trade name), available from Toyo Moton Co., and the resultant laminates were press-cut in a prescribed blade size to produce developer level control blades. Here, the developer level control blades were each 200 mm in length as size in the lengthwise direction and 5 mm in width. Also, the face transferring sheets were peeled and the surface roughness Rz (ten-point average roughness) of each of the charge control faces of the blade members before use was measured with SURFCORDER SE3500 (trade name), manufactured by Kosaka Laboratory Ltd., to find that it was 0.2 μm.

The developer level control blades obtained as described above were fitted in the same manner as in Example 6 to evaluate the stability of adherence between blade member and support member and the state of charge control face according to three ranks: good (A), rather good (B) and poor (C). The other performances of the blade were evaluated in the same manner as in Example 6. The results are shown in Table 4.

TABLE 4

| | Example | | |
|---|---|---|---|
| | 13 | 14 | 15 |
| Surface roughness Rz | 1.5 | 3.0 | 5.0 |
| of roughened-surface roll: | | | |
| (μm) | | | |
| Surface roughness Rz | 1.0 | 2.5 | 4.0 |
| of bond area: | | | |
| (μm) | | | |
| Triboelectricity: | −23 | −23 | −23 |
| (μC/g) | | | |
| State of coating: | A | A | A |
| Solid-black density: | 1.4 | 1.5 | 1.4 |
| Adhesion stability: | A | A | A |
| State of charge control face: | A | A | A |

As is evident from Table 4, it has been found that the surface-roughing of the blade member on its side to which the support member is to be bonded can achieve sufficient adherence between the blade member and the support member. Also, where the blade member was formed in a thickness of 30 μm, the blade was able to be more improved in its performance.

Next, the working examples which forcuses attention on the preparation process of the blown-film molding are explained.

### Example 16

As a resin for the blade member, a polyester elastomer (trade name: HYTREL 4047; available from Du Pont-Toray Co., Ltd.) was melted at 250° C. As a resin for the face transferring sheet, polypropylene (trade name: UBE POLYPRO J309GL; available from Ube Industries, Ltd.) was melted at 180° C. These were co-extruded to carry out double-layer blown-film extrusion in such way that the polypropylene came to the outer layer of the cylindrical product. Incidentally, the polyester elastomer layer was so formed as to have a thickness of 50 μm after solidifying, the polypropylene layer was so formed as to have a thickness of 50 μm after solidifying. The cylindrical product formed of these was cut open in two sheets to obtain double-layer sheets.

The double-layer sheets thus obtained were stretched. To each sheet thus stretched, a phosphor bronze sheet of 0.12 mm in sheet thickness was bonded providing between them an adhesive layer formed of ADCOAT AD-76P1 (trade name), available from Toyo Moton Co., to form a laminate. Here, the bond area of the blade member had a surface roughness Rz of 0.5 μm. The laminate thus obtained was so press-cut that its lengthwise direction fell at right angles with the stretch direction to obtain a developer level control blade. Here, the developer level control blade was 200 mm in length as size in the lengthwise direction and 5 mm in width. Also, the face-transferring sheet was peeled and the surface roughness Rz (ten-point average roughness) of the charge control face of the blade member before use was measured with SURFCORDER SE3500 (trade name), manufactured by Kosaka Laboratory Ltd., to find that it was 0.5 μm. Incidentally, the face-transferring sheet was well peelable.

The developer level control blades obtained as described above were fitted in the same manner as in Example 6 to evaluate the stability of adherence between blade member and support member and the state of charge control face according to three ranks: good (A), rather good (B) and poor (C). The other performances were evaluated in the same manner as in Example 6. The results are shown in Table 5.

### Example 17

A developer level control blade was produced in the same manner as in Example 16 except that the polypropylene layer was in a thickness of 80 μm after solidifying and, in the double-layer sheet obtained, the polyester elastomer layer was surface-roughed with the roller (surface roughness Rz: 2.5 μm) on its side not coming into contact with the polypropylene layer. Evaluation was made in the same way. Here, the bond area of the blade member had a surface roughness Rz of 2.5 μm. The results are shown in Table 5.

### Example 18

A developer level control blade was produced in the same manner as in Example 16 except that the polypropylene layer was in a thickness of 150 μm after solidifying and, in the double-layer sheet obtained, the polyester elastomer layer was surface-roughed with the roller (surface roughness Rz: 2.0 μm) on its side not coming into contact with the polypropylene layer. Evaluation was made in the same way. Here, the bond area of the blade member had a surface roughness Rz of 2.0 μm. The results are shown in Table 5.

### Example 19

A developer level control blade was produced in the same manner as in Example 18 except that the polyester elastomer layer was in a thickness of 100 μm after solidifying and the polypropylene layer was in a thickness of 100 μm after solidifying. Evaluation was made in the same way. Here, the bond area of the blade member had a surface roughness Rz of 2.0 μm. The results are shown in Table 5.

TABLE 5

| | Example | | | |
|---|---|---|---|---|
| | 16 | 17 | 18 | 19 |
| Blade member thickness: | 50 | 50 | 50 | 100 |
| (μm) | | | | |
| Face transferring sheet thickness: | 50 | 80 | 150 | 100 |
| (μm) | | | | |
| Surface roughness Rz | 0.5 | 2.5 | 2.0 | 2.0 |
| of bond area: | | | | |
| (μm) | | | | |
| Triboelectricity: | −23 | −23 | −23 | −23 |
| (μC/g) | | | | |
| State of coating: | A | A | A | A |
| Solid-black density: | 1.4 | 1.5 | 1.4 | 1.4 |
| Adhesion stability: | A | A | A | A |
| State of charge control face: | A | A | A | A |

As is evident from Table 5, it has been found that a high-performance developer level control blade can be produced by producing the blade member by multi-layer blown-film extrusion. Also, where the blade member was formed in a thickness of 30 μm, the blade was able to be more improved in its performance.

Next, the working examples which forcuses attention on the releasability between the face transferring sheet layer and the blade member layer are explained.

### Example 20

A developer level control blade was produced in the same manner as in Example 16 except that, at the time of co-extrusion, air of 50° C. was upward blown to the space between the polyester elastomer layer and the polypropylene layer. Evaluation was made in the same way. Here, the bond area of the blade member had a surface roughness Rz of 0.5 μm, and the face-transferring sheet showed an especially good releasability. The results are shown in Table 6.

### Example 21

A developer level control blade was produced in the same manner as in Example 17 except that, at the time of co-extrusion, nitrogen gas of 50° C. was upward blown to the space between the polyester elastomer layer and the polypropylene layer and that the polypropylene layer was formed to have a thickness of 50 μm after solidifying. Evaluation was made in the same way. Here, the bond area of the blade member had a surface roughness Rz of 2.5 μm, and the face-transferring sheet showed an especially good releasability. The results are shown in Table 6.

TABLE 6

| | Example | |
|---|---|---|
| | 20 | 21 |
| Blade member thickness: | 50 | 50 |
| (μm) | | |
| Face transferring sheet thickness: | 50 | 50 |
| (μm) | | |
| Surface roughness Rz | 0.5 | 2.5 |
| of bond area: | | |
| (μm) | | |
| Triboelectricity: | −23 | −23 |
| (μC/g) | | |
| State of coating: | A | A |
| Solid-black density: | 1.4 | 1.5 |
| Adhesion stability: | A | A |
| State of charge control face: | A | A |

As is evident from Table 6, it has been found that the blowing of air as a tack reducing agent between the face transferring sheet layer and the blade member layer has enabled an improvement in releasability of the face transferring sheet.

### Example 22

A developer level control blade was produced in the same manner as in Example 6 except that, as the face-transferring sheet, polypropylene film produced by extrusion and being 0.1 mm in thickness and 0.2 μm in surface roughness Rz was used and that the width of the developer level control blade was changed to 23 mm. Evaluation was made in the same way. The apparent Young's modulus as measured at a touching force of 0.49 N was 154 kN/mm², and substantially the same performance as that in Example 6 was ascertained. Also, where the blade member was formed in a thickness of 30 μm, the blade was able to be more improved in its performance.

### Example 23

A developer level control blade was produced in the same manner as in Example 7 except that, as a face-transferring sheet, polypropylene film produced by extrusion and being 0.1 mm in thickness and 0.2 μm in surface roughness Rz was used and that the width of the developer level control blade was changed to 23 mm. Evaluation was made in the same way. The apparent Young's modulus as measured at a touching force of 0.49 N was 162 kN/mm², and substantially the same performance as that in Example 7 was ascertained. Also, where the blade member was formed in a thickness of 30 μm, the blade was able to be more improved in its performance.

The use of the developer level control blade according to the present invention enables highly precise control of the ability to triboelectrically charge the developer on the developer carrying member, making it possible to keep faulty images from occurring, to perform good image formation. Further, according to the manufacturing process according to the present invention, good productivity can be achieved for the developer level control blade having such an effect. Also, the use of the face transferring sheet in manufacturing the developer level control blade enables formation of the desired charge control face at the surface of the blade member in a good productivity. Moreover, the use of the polyester elastomer as the raw material for the blade member enables the developer level control blade to be provided which is suited for developing process required to be made high-speed and highly durable.

In the developing assembly as well, the developer level control blade is disposed the surface free energy of the charge control face of which has been so controlled that, under circumstances where the processing speed is made higher and the apparatus are made more highly durable, and during long-term service, it can make stable the charge-providing performance to toner, can keep development lines from occurring because of the sticking or melt-adhering of toner to the charge control face of the blade member kept in touch with the developer carrying member, and can control the developer level at a low stress to toner particles. This can provide good images free of fog and development lines.

This application claims priority from Japanese Patent Application Nos. 2004-150694 filed May 20, 2004, 2004-150695 filed May 20, 2004, and 2004-144037 filed May 17, 2005, which are hereby incorporated by reference herein.

1. A developer level control blade which has a stated peripheral shape, is to be disposed in touch with a developer carrying member for transporting a developer, holding the developer on its surface, and is used to control the level of the developer to be held on the surface of the developer carrying member; the control blade having a laminated structure in which a support member and a blade member are bonded; wherein;
said blade member is formed of an elastic material containing at least a resin having a polar group,
where the surface free energy γs of the surface that is to come into touch with the developer carrying member, of said blade member is represented by the sum total of a dispersion component γsd, a bipolar component γsp and a hydrogen bond component γsh, the surface free energy γs is 65 mN/m or less, the bipolar component γsp is 35 mN/m or less and the hydrogen bond component γsh is 5 mN/m or less.

2. The developer level control blade according to claim 1, wherein said blade member has a Shore D hardness of from 25 degrees to 78 degrees.

3. The developer level control blade according to claim 1, wherein said blade member comprises a polyester elastomer.

4. The developer level control blade according to claim 1, which has a thickness of from 51 μm or more to 450 μm or less.

5. The developer level control blade according to claim 1, wherein said blade member has a thickness of from 1 μm or more to 300 μm or less and said support member has a thickness of from 50 μm or more to 150 μm or less, both in the thickness direction of the laminated structure.

6. The developer level control blade according to claim 1, wherein the surface of said blade member on the side opposite to the side on which said blade member is to be bonded to said support member is formed as a charge control face, and the surface has a ten-point average roughness Rz of not more than 3.5 μm.

7. The developer level control blade according to claim 1, which has an apparent Young's modulus Ea of from 140 kN/mm² or more to 170 kN/mm² or less.

8. A developing assembly which comprises a developer carrying member for holding a developer on its surface to carry the developer out of a developer container, and a developer level control blade kept in touch with the developer carrying member, for controlling the level of the developer held on the surface of the developer carrying member, wherein;
said developer level control blade is the developer level control blade according to any one of claims 1 to 7.

9. A process for manufacturing a developer level control blade which has a stated peripheral shape, is to be disposed in touch with a developer carrying member for transporting a developer, holding the developer on its surface, and is used to control the level of the developer to be held on the surface of the developer carrying member; the process comprising the steps of:
extruding a elastic raw material containing a resin having a polar group, onto a charge control face face-transferring sheet, followed by solidification to prepare on a charge control face face-transferring sheet a blade member layer in which, where the surface free energy γs of the surface that is to come into touch with the developer carrying member is represented by the sum total of a dispersion component γsd, a bipolar component γsp and a hydrogen bond component γsh, the surface free energy γs is 65 mN/m or less, the bipolar component γsp is 35 mN/m or less and the hydrogen bond component γsh is 5 mN/m or less;
laminating and bonding a support member layer to the top surface of the blade member layer to obtain a laminate; and
cutting the laminate in a stated peripheral shape to obtain a developer level control blade having a laminated structure in which a blade member and a support member are bonded.

10. The process for manufacturing a developer level control blade according to claim 9, wherein said blade member is formed of a polyester elastomer having a Shore D hardness of from 25 degrees to 78 degrees.

11. The process for manufacturing a developer level control blade according to claim 9, wherein said developer level control blade has a thickness of from 51 μm or more to 450 μm or less.

12. The process for manufacturing a developer level control blade according to claim 9, wherein said blade member has a thickness of from 1 μm or more to 300 μm or less and said support member has a thickness of from 50 μm or more to 150 μm or less, both in the thickness direction of the laminated structure.

13. The process for manufacturing a developer level control blade according to claim 9, wherein the surface of said blade member on the side opposite to the side on which said blade member is to be bonded to said support member is formed as a charge control face, and the surface has a ten-point average roughness Rz of not more than 3.5 μm.

14. The process for manufacturing a developer level control blade according to claim 9, wherein said developer level control blade has an apparent Young's modulus Ea of from 140 kN/mm² or more to 170 kN/mm² or less.

15. The process for manufacturing a developer level control blade according to claim 9, wherein said face transferring sheet comprises at least one resin selected from the group consisting of a polyester resin, a polyamide resin, a polyolefin resin, a copolymer of any of these, and an alloy of any of these.

16. The process for manufacturing a developer level control blade according to claim 15, wherein said face transferring sheet comprises at least one selected from the group consisting of polyethylene terephthalate, polyethylene-2,6-naphthalate, a copolymer of these, and a composite of these.

17. The process for manufacturing a developer level control blade according to claim 15, wherein said face transferring sheet have a thickness of from 1 μm or more to 200 μm or less.

18. The process for manufacturing a developer level control blade according to claim 9, wherein the step of preparing said blade member layer is carried out by roll coating, and a roll disposed on the side of the raw material for the blade member has a rough surface.

19. The process for manufacturing a developer level control blade according to claim 18, wherein said rough surface has a ten-point average roughness Rz of from 1.5 μm or more to 5.0 μm or less.

20. The process for manufacturing a developer level control blade according to claim 9, wherein said face transferring sheet is not peeled in the middle of the manufacturing process.

21. A process for manufacturing a developer level control blade which has a stated peripheral shape, is to be disposed in touch with a developer carrying member for transporting a developer, holding the developer on its surface, and is used to control the level of the developer to be held on the surface of the developer carrying member; the process comprising the steps of:
co-extruding i) a face transferring sheet forming molten resin material which is to form a charge control face face-transferring sheet and ii) a molten resin material for forming a blade member comprising an elastomer containing a resin having a polar group, followed by shaping into a cylindrical form by multi-layer blown-film extrusion to obtain a cylindrical product in which a face transferring sheet and a blade member layer are laminated in which, where the surface free energy γs of the surface that is to come into touch with the developer carrying member is represented by the sum total of a dispersion component γsd, a bipolar component γsp and a hydrogen bond component γsh, the surface free energy γs is 65 mN/m or less, the bipolar component γsp is 35 mN/m or less and the hydrogen bond component γsh is 5 mN/m or less;
cutting the cylindrical product in parallel to the direction of extrusion to form at least one raw-material sheet;
laminating a support member layer to the raw-material sheet on its blade member layer to obtain a laminate; and
cutting the laminate in a stated peripheral shape to obtain a developer level control blade having a laminated structure in which a blade member and a support member are bonded.

22. The process for manufacturing a developer level control blade according to claim 21, wherein said blade member is formed of a polyester elastomer having a Shore D hardness of from 25 degrees to 78 degrees.

23. The process for manufacturing a developer level control blade according to claim 21, wherein the surface of said blade member on the side opposite to the side on which said blade member is to be bonded to said support member is formed as a charge control face, and the surface has a ten-point average roughness Rz of not more than 3.5 μm.

24. The process for manufacturing a developer level control blade according to claim 21, wherein said developer level control blade has an apparent Young's modulus Ea of from 140 kN/mm² or more to 170 kN/mm² or less.

25. The process for manufacturing a developer level control blade according to claim 21, wherein the resin contained in said face transferring sheet forming molten resin material comprises a straight-chain polymer containing no polar group.

26. The process for manufacturing a developer level control blade according to claim 25, wherein said straight-chain polymer containing no polar group is an olefin polymer.

27. The process for manufacturing a developer level control blade according to claim 21, wherein said developer level control blade has a thickness of from 51 μm or more to 450 μm or less.

28. The process for manufacturing a developer level control blade according to claim 21, wherein said blade member has a thickness of from 1 μm or more to 300 μm or less and said support member has a thickness of from 50 μm or more to 150 μm or less, both in the thickness direction of the laminated structure.

29. The process for manufacturing a developer level control blade according to claim 21, wherein, in co-extruding said face transferring sheet forming molten resin material and said blade member forming molten resin material, a tack reducing agent is fed between layers of said face transferring sheet forming molten resin material and said blade member forming molten resin material.

30. The process for manufacturing a developer level control blade according to claim 29, wherein said tack reducing agent is air, an inert gas or a gas containing tack-free fine particles.

31. The process for manufacturing a developer level control blade according to claim 30, wherein said face transferring sheet which constitute said raw-material sheet have a thickness of from 1 μm or more to 200 μm or less.

32. The process for manufacturing a developer level control blade according to claim 21 wherein, in cutting said laminate in a stated peripheral shape, said laminate is cut in such a way that the direction of orientation of said blade member forming molten resin material falls substantially at right angles with the lengthwise direction of said blade member.

33. The process for manufacturing a developer level control blade according to claim 21, wherein, before the support member layer is laminated onto said raw-material sheet, the surface of said blade member layer is roughened on its side to be bonded to the support member layer.

34. The process for manufacturing a developer level control blade according to claim 33, wherein the surface roughened has a ten-point surface roughness Rz of from 1.5 μm or more to 5.0 μm or less.

35. The process for manufacturing a developer level control blade according to claim 21, wherein the face transferring sheet is not peeled in the middle of the manufacturing process.
